(19) United States
(12) Patent Application Publication
(10) Pub. No.: US 2022/0407349 A1
(43) Pub. Date: Dec. 22, 2022

(54) METHOD FOR RAPIDLY CHARGING AN ELECTRIC VEHICLE FROM A LIGHT DUTY CHARGING SITE COMPRISING A RESIDENTIAL DWELLING OR A SMALL OFF GRID POWER STATION

(71) Applicant: Thomas Llewellyn Owens, Fairmont, WV (US)

(72) Inventor: Thomas Llewellyn Owens, Fairmont, WV (US)

(21) Appl. No.: 17/352,028

(22) Filed: Jun. 18, 2021

(51) Int. Cl. H02J 9/06; H02J 7/35; B60L 53/18; B60L 53/51; B60L 53/22

(52) U.S. Cl. CPC H02J 9/062; H02J 7/35; B60L 53/18; B60L 53/51; B60L 53/22; B60L 2210/40

(57) ABSTRACT

A fast-charging method is provided for rapidly charging an electric vehicle at a light-duty charging site comprising a residential dwelling or a small off-grid power station. The fast charging method incorporates an intermediate battery bank, or power buffer, that stores energy between EV charging cycles, then discharges the stored energy into the EV at a higher rate than the primary electric power source for the charging system. The power buffer thereby acts as a power multiplier that accelerates the rate of charge of an electric vehicle. Substantial power multiplication factors are possible at light-duty charging sites, resulting in large improvements in electric vehicle charging rates. The method may be applied using a number of primary power sources including AC from the utility grid, DC from photovoltaic panels, or power from other electric vehicle chargers (including both AC and DC electric vehicle chargers).

### BACKGROUND OF THE INVENTION

### 1. Technical Field

The present invention relates generally to electric chargers and electric charging methods for battery powered electric vehicles. More specifically, the invention relates to new uses for high- power electric charging methods that charge an energy storage load onboard an electric vehicle by means of a rechargeable energy storage battery that is offboard the electric vehicle.

### 2. Background and Related Art

In its broadest sense, an electric vehicle (EV) can include any moving vehicle that is powered by electricity. Some of the most commonly used EV types to which the present invention applies include battery-powered electric automobiles (electric cars), light-duty electric trucks, electric bicycles, electric motor scooters, electric motorcycles, electric carts (e.g., electric golf carts, recreational carts, and utility carts), and electric fork-lift trucks. This list is exemplary and does not limit the scope of possible EV applications to which the invention applies.

Currently, the long time required to recharge batteries onboard EVs constitute one of the most significant drawbacks to EVs and one of the greatest impediments to widespread adoption and widespread use of EVs. Slow battery charging for electric automobiles is a particularly serious problem because of the enormous size of automobile markets. Efforts to improve EV charging rates have focused upon novel EV battery chemistries for which there is a large body of prior art. Great improvements have been made in specific energy and specific power of rechargeable batteries for EVs while battery costs have been steadily dropping. Currently, EV batteries are commercially available that can be recharged in as little as six minutes. Rechargeable batteries with even faster charging speeds are on the horizon. With recharge times this fast, EV batteries are not necessarily the bottleneck in charging speed. Rather, charging speeds are now limited by the EV battery charger and EV battery charging infrastructure. To help curtail this limitation in electric vehicle technologies, this disclosure will focus on improvements in EV battery charging and EV battery charging infrastructure.

More specifically, a method will be described for enabling fast EV charging in under-served situations where only one or a small number of EVs are charged each day and EV charging times are undesirably long. These situations occur, for example, in EV charging from a home (residential dwelling) charger or a small off-grid power station. A small off-grid power station in the context of the present invention can be made up of one or a combination of field-deployable power sources, including, in particular, a photovoltaic power source, a motor-driven generator, or a wind turbine generator. A small off-grid power station may be fixed or transportable with typical power levels on the order of approximately 50 kW or less. A transportable off-grid power station may not necessarily be equipped with wheels for transport. In some cases, the transportable power station may be equipped with a skid or pallet that can be loaded onto a truck using a forklift or other heavy-lift equipment. A transportable power station can even comprise a small power source that can be hand carried.

It is also assumed throughout this disclosure that compatible fast-discharge EV batteries are available that have power discharge levels exceeding the power level of the primary power source used to charge the batteries. The focus of this disclosure will be upon EV charging methods that may be applied to existing battery technologies in light-duty charging situations that have unmet needs for large improvements in EV charging rates.

The term “energy storage load” herein designates broadly a system for storing energy onboard an electric vehicle. Common energy storage loads include rechargeable batteries and supercapacitors. Other energy storage loads may include ordinary capacitors and flywheel energy storage systems. Energy is typically supplied from an electric charger to an energy storage load via an electric current supplied by the charger. A rechargeable-battery energy storage load accumulates and stores energy via a reversible chemical process driven and sustained by electric charger current. Capacitor energy storage loads accumulate and store energy by collecting and holding electric charge supplied directly by the electric charger current. A flywheel energy storage load utilizes charger current to drive a motor that turns a rotating flywheel. The flywheel, in turn, stores energy through flywheel inertia and subsequently releases that energy by turning an electric generator mechanically and rotatably linked to the flywheel.

Of the various energy storage loads that relate to the present invention, rechargeable batteries comprise one of the most widespread application areas for an electric charger and electric charging methods. The following discussion will focus on charging methods for battery loads by way of example, as it represents a significant application area. It should be clear from the discussion in the previous paragraph that other energy storage loads exist to which the present invention may also apply.

With respect to the charging process for accumulating and storing energy in a rechargeable battery in common practice, the electric charger supplies a constant current to a depleted battery until the device voltage approaches a predetermined voltage level, typically near the maximum battery voltage rating. At this point, charging current is decreased in a programmed fashion so that the battery voltage may be maintained at or below the predetermined voltage set point. A number of other methods exist for electric charging of rechargeable batteries that tailor the current and voltage waveforms in a purposeful manner to improve charge rate, device lifetime, device temperature, or various other operating parameters. For example, charging currents may be repetitively pulsed, or applied at various levels over multiple steps in order to improve maximum charge rates in rechargeable batteries.

Typically, a rechargeable battery in an electric vehicle consists of multiple rechargeable battery cells connected in various series and parallel configurations. The collection of rechargeable battery cells will be referred to collectively throughout this disclosure simply as the “EV battery” or the “battery” without delineating the individual cellular configuration or makeup of the battery. Prior art methods for EV battery charging generally involve direct conversion of primary AC power from the electric utility lines into DC power that may be concurrently applied to the EV battery at a power level substantially equal to or somewhat less than the primary input AC power. In this common EV charging situation, the total power, or peak power, applied to the EV battery is substantially equal to the AC power from the utility grid.

High peak power demand from the utility grid in this common scenario can add substantially to the cost of utility power in many situations. Measures have therefore been taken in the prior art to minimize peak power demand from the primary power source used for EV charging. More specifically, some EV charging methods apply primary AC power through an AC/DC converter to a secondary or intermediate energy storage battery that is offboard the EV and typically stationary. This secondary battery acts as an intermediate energy storage buffer between the AC/DC converter and the primary energy storage battery onboard the EV. This intermediate buffer will be referred to as the “energy storage buffer” and the method for applying the energy storage buffer will be referred to as the “energy buffering method.” The energy storage buffer then acts as the charging source for the primary EV battery. The primary EV battery, in turn, supplies power to the EV motors and EV accessories.

The energy storage buffer is utilized advantageously in the prior art to store energy from the AC utility lines when the EV charger is idle between charging cycles. Direct current (DC) output from the energy storage buffer is then used to charge the primary battery within the EV. The utility lines need supply only the average power needed for energy storage rather than the peak charging power supplied by the energy storage buffer so that peak-power costs imposed by the utility companies are substantially reduced. This advantageous function of the energy buffering system will be referred to as “peak power shaving.”

When state-of-the-art fast-discharge rechargeable power cells are utilized in an energy storage buffer, the energy buffer can not only store energy, but it can also supply a substantially larger peak charging current than the AC utility lines alone. For the purposes of this disclosure, a fast-discharge battery will comprise any rechargeable battery capable of discharging rates in excess of approximately 2 C (double the battery current rating for a one-hour discharge). When an energy buffer is equipped with fast-discharge batteries, the energy buffer will be referred to as a “power buffer” to make it clear that energy is not only stored in a power buffer, but the energy discharge rate (discharge power) is multiplied in a power buffer. The ability to advantageously multiply or amplify power in a power buffer will be referred to herein as “power multiplication” or “power boost.” The overall charging method utilizing a power buffer will be referred to as the “power buffering method” to distinguish it from an energy buffering method in which power may not be substantially multiplied.

For the purposes of this disclosure, power multiplication factors in excess of approximately 1.4 will be considered substantial multiplication factors for electric vehicles. EV charging at power multiplication factors greater than 1.4 will then be considered “rapid charging” or “fast charging” throughout this disclosure. Correspondingly, for a multiplication factor greater than 1.4, the power factor in the charging cycle will typically be less than approximately 0.7. Larger charging power and associated currents enabled by power multiplication in this power buffering method translate directly into increased EV charging speeds.

The broad energy buffering method has been described in the public literature, but primarily in the context of an energy storage system rather than a power multiplication system. For example, Tesla, Inc., LG Chem, Ltd., and Sonnen, Inc., each offer a rechargeable battery buffering system for storing energy in residential dwellings, but continuous power output from each system is limited to less than about 10 kW. These systems would then charge a typical EV with a 50 kW-hr battery to 80% capacity in about four hours, making these commercial battery buffering systems unsuitable for fast-charging of EVs. In particular, the 10 kW limit of these existing battery buffer systems is already available from the primary AC power source in a residential dwelling, so that power multiplication factors for these existing energy buffering systems are less than one, decisively eliminating them from the general class of fast chargers that implement power buffering as described herein. Rather, these existing energy buffering systems are intended primarily for renewable energy storage, battery backup during power outages, and programmable reserve power.

Applications for the energy buffering method in the context of bulk energy storage rather than fast EV charging have also been disclosed for publicly shared EV charging stations where many EVs may be charged throughout the day. The advantages of the energy buffering method in shared charging facilities are acknowledged in the prior art primarily with respect to peak power shaving resulting from the energy storage feature. The potential for power multiplication using a power buffer is under-appreciated and under-acknowledged at shared EV charging facilities since the potential power multiplication factors at a heavily utilized EV charging station are typically low (e.g., less than approximately 1.4) since there is relatively little idle time between charging cycles to accumulate and store substantial charge in a power buffer. In other words, the prior art has emphasized the energy buffering method for its energy storage and associated power shaving benefits, but has not fully recognized or appreciated the stand-alone advantages and added benefits of power multiplication for fast EV charging inherent in the power buffering method.

Without fully appreciating the great advantages of power multiplication in power buffering methods, a large body of EV charging applications with need for substantial improvement in charging speed have been neglected. In particular, applications have been neglected where only one or a relatively small number of EVs are charged each day (light-duty charging sites). In these light-duty applications, there can be ample time to accumulate large amounts of energy in an energy storage load and power multiplication factors can be especially large, leading to large increases in charging speed that can meet the long-felt need for substantial increases in EV charging speed in light-duty applications.

EV charging sites can be classified as “light-duty” at any primary power level as long as EV volumes are relatively low. On the other hand, EV charging sites possessing relatively low primary power are characteristically light-duty, since primary power is insufficient to charge large numbers of EVs. At low-power EV charging sites, relatively long periods of time are necessary for charging an EV in the prior art and the EV cannot be used during this extended charging interval. As important examples, standard Level 1 and Level 2 charging stations found in the prior art would fall in this low-power, light-duty EV charging category. Many hours are required to charge an EV using these prior art EV chargers. Improvements in charging speed at these light-duty stations would be highly valued.

As a specific example, electric automobile chargers at residential dwellings (home-based systems) would constitute a particularly large body of EV charging infrastructure that would be classified as light-duty charging sites. There is presently no power multiplication or power boost feature at these charging sites. Rather, power to charge EV batteries is substantially equal to the AC power available within the residential dwelling that has its source in utility power lines connected to the home. As will be shown in the Detailed Description, using power buffering methods at residential sites in accordance with the invention, it is possible to achieve surprising multiplication factors of thirty or more, making the power buffering method extremely desirable for fast charging of electric automobiles in home-based charging systems.

Such large power multiplication factors are possible in a home-based system using the present invention due to long idle periods between charging cycles where only one or a few vehicles may be charged in a single day. With long periods of time available for charging the power buffer, large amounts of energy could be accumulated and stored in a fast-discharge battery within the power buffer. The substantial advantages of the power multiplication feature of the power buffering method and the large and surprising power multiplication factors that are possible in a home-based EV charging station have been unrecognized and unacknowledged in the prior art and there have been no efforts to develop a power buffering system for fast EV charging at home-based charging sites, despite its great advantages.

Other low power, light-duty EV charging situations that would greatly benefit from power multiplication in a power buffer include any EV charging site that uses a relatively small off-grid power source (typically less than about50 kilowatts), including combinations of small engine-driven generators, solar photovoltaic panels, and wind turbine generators. This general category of applications utilizing a small off-grid power source (small off-grid power station) would include military operations, emergency response activities, construction sites, and special outdoor events. In all of these situations, field-deployed motor-driven generators, solar photovoltaic panels, and wind turbine generators are utilized frequently because power from an electric grid is unavailable and/or inaccessible. Once again, there has been no recognition of the advantages of power boost using a power buffer nor any attempt to apply power boost for fast EV charging in these relatively low-power, light-duty charging situations, despite the great advantages of quick turn-around of EVs and substantially improved EV availability resulting from fast charging of depleted EV batteries.

Finally, there is an unmet need to increase the EV charging speed of primary EV chargers at many types of shared public charging stations for electric automobiles. The present invention can serve this need in common situations at shared public charging stations in which charging volumes are low and/or charging power levels are moderate. In particular, it may presently take from about one to several hours to fully charge a single electric automobile at a public charging station. While these charging times are substantially shorter than charging times at home-based charging sites and many other light-duty charging sites, they are still excessive for many electric automobile owners and inhibit widespread acceptance of electric automobiles. It would therefore be desirable to implement a system for increased EV charging rates even at many shared public charging stations.

Since many thousands of conventional charging stations for electric automobiles have been installed around the world with undesirably long EV dwell times for charging, it would be particularly advantageous to increase charging rates at these existing EV charging stations in a manner that could utilize existing infrastructure with minimal disruption or modification of the current network of public charging stations. The power boost feature of a power buffer would have great advantages for this purpose at shared public charging stations whenever charging volumes are low, as is frequently the case. It would be particularly advantageous if existing infrastructure could be retrofitted with fast-charging power buffer upgrades with minimal modification to the charging stations.

Note that while periods of light-duty charging may occur at shared public charging stations, high power levels may be involved during the charging cycle, unlike some of the light-duty applications discussed previously. The potential to retrofit existing shared public charging stations with increased EV charge-rate capability using the power boost feature of the power buffering method has been unrecognized and its advantages unappreciated and unacknowledged in the prior art.

### OBJECTS AND ADVANTAGES

It is a general object of the present invention to provide new and unanticipated uses for the power boost feature of the power buffering method to rapidly charge electric vehicles in light-duty applications where only one of a relatively small number EVs are charged each day, and/or wherever and whenever there is substantial idle time between charging cycles at the charging site. More specifically, the power buffering method forms the basis for the present method for fast EV charging in under-served situations where relatively low EV charging volumes (light duty applications) are involved that enable relatively long idle periods for accumulating substantial energy in a power buffer that may be subsequently discharged at a high rate into an EV battery for fast charging of an EV. The need for increased charging speeds in light-duty situations is particularly acute since present charging times at common light-duty sites are excessive using conventional charging methods.

The present invention is effective and advantageous even when peak power shaving is not implemented. This feature helps distinguish the present invention from the prior art, as peak power shaving is emphasized over power multiplication in traditional prior art methods that rely upon energy buffering rather than power buffering. In particular, the new-uses for the present invention stem directly from the unacknowledged advantage that large power multiplication factors inherent in the power buffering method can enable fast EV charging to great advantage in situations where only low EV charging volumes are involved (light duty applications), peak power shaving is not a primary consideration, and/or only relatively low primary power may be available.

Under-served EV charging situations having the greatest need for increased charging rates in the face of relatively low EV volumes and low primary power to which the invention may apply most effectively and substantially include: residential dwellings/homes, temporary shelter sites, and small off-grid power stations (e.g., photovoltaic, wind turbine, or small engine generator sites). Off-grid power stations may provide electric power for a variety of field activities where power from a large power grid is inaccessible. These activities may include military maneuvers, emergency response, construction projects, and special events (e.g., outdoor conventions, fairs, sporting events, and social venues). The terms “residential dwelling” or “dwelling” or “residence” or “home” are understood throughout this disclosure to include single-family homes, apartments, mobile homes, houseboats, or any other substantial structure used for human habitation. It is an object of the present invention to charge electric vehicles in all of these situations at unanticipated charging rates by means of power multiplication in a power buffer that is supplied by a relatively low-power primary source, as will be described in more detail in this disclosure.

It is a further object of the present invention to enable unexpectedly large increases in EV charging rates from a garage or interior space of a residential dwelling using nominal 120 Volt single-phase AC power from any common residential outlet. Using state-of-the art rechargeable EV batteries in some embodiments of the present invention, energy can be stored in the power buffer throughout the day from an ordinary residential outlet to fully charge an electric automobile in less than ten minutes, instead of the present practice of home charging an electric automobile in 11-30 hours for a standard Level 1 charger using a comparable 120 Volt power source at a dwelling. To achieve these exceedingly large increases in electric automobile charging rates from an ordinary 120 Volt home outlet, large power multiplication factors are implemented in the present invention that have not been implemented nor anticipated in the prior art for EV charging from a dwelling. This magnitude of increase in charging rates is, in fact, both surprising and unexpected in the art of EV charging in a residential dwelling.

It should be understood that reducing EV charging time from a residential dwelling to ten minutes by the disclosed method for fast EV charging is only one example of what is presently possible in a residential dwelling. Even faster EV charging rates may become widespread in the near future as new battery technologies become widely available commercially. For example, StoreDot, Ltd., claims to have developed a fast-discharge battery for commercial EV use that can be fully charged in only five minutes onboard an electric automobile. It is an object of the present invention to provide fast-charging of the StoreDot battery as well as other fast-discharge EV batteries known in the art that would be utilized in EVs. It should also be clear that there is considerable room for improvement in EV charging speeds at a residential dwelling, and that much more modest increases in EV charging rates (i.e., longer than ten minutes) could still constitute major improvements in charging speed that would retain substantial benefits and advantages at a residential dwelling.

It is a further object of the present invention to enable substantially increased EV charging rates from a garage or interior space of a residential dwelling using nominal 240 Volt two-phase AC power that is accessible in most residential dwellings. Current EV charging practice using a conventional Level 2 charger operating from a 240 Volt power source in a residential dwelling would typically require a few hours to several hours to charge an EV. It is a specific object of the present invention to reduce these charging times from standard Level 2 chargers and increase EV charging speed by factors from approximately 1.4 to 30 or more in a residential dwelling. Increases in EV charging speed of this magnitude in a residential dwelling are both surprising and unexpected.

It is a further object of the present invention to provide improved EV availability for on-road travel due to rapid EV charging from home, enabling more flexible EV use and EV scheduling that is more responsive to owner needs and owner driving patterns. For example, rapid charging of electric automobiles from the home will enable the use of EVs during emergencies or other urgent or unplanned situations where an on-road vehicle is needed as soon as possible and a long charging period is undesirable or cannot be tolerated. By satisfying this object, the electric automobile owner will no longer be stranded at home due to extremely slow EV charging rates limited by low power limitations of typical residential dwellings.

It is a further object of the present invention to provide a power buffer that can utilize previously used rechargeable batteries that have been removed from EV service because of diminished capacity that makes the batteries unsuitable for powering an EV. In spite of diminished capacity, these used, or repurposed, EV batteries can have substantial useful lifetime and sufficient capacity for use in the power buffer of the present invention. In most cases, repurposed batteries can serve effectively in the power buffer of the invention for many years. In addition, by extending the useful life of rechargeable batteries in repurposed applications, the rate of EV battery disposal can be reduced, helping to mitigate the environmental impact of EV battery disposal.

It is a further object of the present invention to provide an EV charger for a dwelling that has multiple uses in and around the home. For example, energy stored in the power buffer can be used as backup power for the home by adding an inverter to the power buffer to convert the power buffer's DC into AC for the home. This feature eliminates the need for a separate motorized backup generator during power outages on the grid. The power backup feature of the present invention distinguishes the present invention from chargers and charging methods at shared public charging stations, including public charging stations that utilize energy storage buffers, since the primary purpose of a public charger is to recharge EVs, rather than power a variety of appliances, electronics, and electrical equipment during a power outage.

It is a further object of the invention to utilize the rechargeable battery in the power buffer to store energy from a solar photovoltaic panel, or wind turbine generator that might be found in and around some residential dwellings. This source of renewable energy would add to energy supplied to the buffer via a primary electric power source (e.g., AC power from the grid). In connection with renewable power sources in and around a dwelling that use the power buffer of the present invention for energy storage, energy from renewable sources may be injected into the utility grid by adding an inverter synchronized with the utility power source. This inverter can be the same inverter used for the power backup feature of the power buffer described previously for the present invention.

It is a further object of the invention to provide means for transporting the power buffer so that it can be advantageously utilized as a mobile energy storage system that can provide electric power away from the home utilizing existing elements of the charging station contained in the home. To provide AC power for common electrical devices away from the home, the power buffer power may be equipped with an inverter to provide transportable AC power. Alternatively, the transportable power buffer may be used without an inverter to supply DC. In particular, this DC source could be used for more direct DC charging of an EV away from home.

When the mobile energy storage system derived from the EV charger is transported by means of the EV itself (e.g., in a trailer towed behind the EV), a source of supplemental energy can be provided for the EV that will extend the range of the EV, which would be especially desirable for minimizing travel times on long distance trips. The mobile energy storage system can also be transported by specialized service vehicles (e.g., tow trucks) in order to provide charge for an EV that has become stranded because of an accidentally depleted EV battery.

It is a further objective of the present invention to provide a lightweight power source for light duty use, including recreational use, such as camping and picnicking, or more generally for powering electronic devices, small electric appliances, and electric power tools. The lightweight power source is formed from a removable and easily transported portion of the power buffer of the present invention and a small inverter to supply relatively low-power AC loads. By utilizing small subassemblies of the charger for a multitude of purposes, added functionality can be provided with relatively little added cost.

It is a further object of the invention to provide fast charging of EVs in military field operations that utilize low-volumes of EVs (light duty) or that can take advantage of long idle periods to accumulate substantial energy in a power buffer for EV charging. In this case, rapid charging of EVs may be critical to fast-paced operational scenarios where power from a large utility grid is inaccessible or inoperative and only relatively low power from a transportable off-grid power station is available in the field. Energy stored in the power buffer of the invention may be applied rapidly to EVs in the field to ensure EVs are ready to use in time-critical military applications that cannot tolerate long EV recharge times.

It is a further object of the invention to provide fast charging of EVs for emergency response activities, including response to national disasters, that utilize low volumes of EVs (light duty applications) or that have long idle periods for accumulating substantial energy in a power buffer. These emergency activities may require EVs in situations where power from a large utility grid is inaccessible or inoperative and only relatively low power from a transportable power station is available in the field. Energy stored in the power buffer of the invention may be applied rapidly to EVs in this situation for fast EV charging that ensures EVs are ready to use when needed for time-critical emergency response and disaster relief efforts. In some cases, rapid charging of EVs in an emergency or disaster relief situation may be needed to save lives and property and/or provide rapid transport of individuals to medical facilities.

It is a further object of the invention to provide fast charging of EVs at construction sites that utilize low volumes of EVs or that have long idle periods for accumulating substantial energy in a power buffer. These construction sites may require EVs in situations where power from a large utility grid is inaccessible or inoperative and only relatively low power from a transportable off-grid power station is available in the field. Energy stored in the power buffer of the invention may be applied rapidly to EVs in this situation for fast EV charging that ensures EVs are ready to use when needed for time-critical construction activities. At construction sites and other grid-independent sites, the invention may be practiced not only to charge EVs used for transportation (e.g., automobiles, trucks, and carts), but also EVs used for material handling, including fast charging of electrically-powered fork-lift trucks.

It is a further object of the invention to apply the power buffering method for fast charging of electric bicycles, electric motor scooters, and electric motorcycles, and electric carts (e.g., golf carts, recreational carts, and utility carts) in addition to electric automobiles and electric trucks. Charging of these types of EVs is typically low-volume and light-duty, making fast-charging of these types of EVs relevant to the present invention. Charging rates for these types of EVs are often undesirably low using prior art charging methods. As consequence of slow charging rates in common practice, these types of EV are frequently unavailable when needed due to depleted batteries. In particular, companies that operate small fleets of electric bicycles, electric scooters, or electric carts may lose customers because EVs cannot be rapidly recharged after each use, making customers wait long periods of time to rent an electric bicycle, electric scooter, or electric cart. Alleviating this issue in the prior art is an object of the present invention.

It is a further object of the invention to provide an add-on or retrofit to existing EV chargers, especially where charging volumes are low or there are substantial idle periods between charging cycles (light-duty applications) where substantial energy may be accumulated in a power buffer. In this case, power from existing EV chargers would serve as the primary power source for the power buffer of the present invention. By this means, power for EV charging at existing EV charging stations could be multiplied to increase EV charging rates. Benefits of power boost where Level 1 and Level 2 chargers are installed at existing facilities would be especially great, but benefits of more modest power multiplication factors would also exist for higher-power Level 3 chargers. An important advantage of this embodiment of the invention is that existing EV charger infrastructure can be used and minimal modification of existing facilities would be required, helping to keep costs low and encouraging rapid and extensive deployment of the invention at existing public and private EV charging stations. Retrofitting existing charging infrastructure with power buffering equipment for rapid EV charging in accordance the present objective represents an unanticipated new use that has not been disclosed in the prior art.

Of substantial advantage for EV charging objectives, energy stored in the power buffer of the present invention can be drawn from primary AC power on a highly flexible schedule throughout the day or night. Of particular significance, the EV does not need to be present while the power buffer is being charged. This advantageous feature does not exist in present practice in light-duty applications, since light-duty applications do not utilize a power buffer. Instead, the EV must be taken out of service during the lengthy charging cycle in prior art methods.

In other terms, energy ultimately applied to the EV from the power buffer can be accumulated at virtually any time during the full 24-hour period of each day, whether or not the EV is present and connected to the charger. Thus, for example, the EV may be driven outside the home while energy for the next EV charge is being accumulated in the power buffer and made ready for the next fast charging cycle of the EV. For operators of fleets of electric bicycles, electric scooters, and electric carts, EVs may be used by customers while energy is being accumulated in a power buffer. Accumulated buffer energy may then be applied to the EVs on a more efficient schedule for high-demand situations in fleet operations. More EV availability in this case helps generate more revenue for EV fleet owners.

In addition to the great flexibility this advantage affords, more time is available to accumulate energy for EV charging, since energy can be accumulated in the power buffer during time periods when the EV is not present. This advantage is especially important when only limited primary source power is available, as in a residential dwelling, and longer times are needed to accumulate a given charge. This extended charging time will enable increased energy storage in the power buffer compared to energy that could otherwise be accumulated in the EV while it is necessarily present and connected to prior art Level 1 or Level 2 chargers at a dwelling.

Finally, because of flexible energy accumulation schedules enabled by the invention, the power buffer can be powered during periods having the lowest possible energy usage rates in locations where utility usage (kW-hr) charges may vary as a function of time throughout the day. This advantage is distinct from the advantage of peak demand (kW) cost reductions that are effective in the prior art using peak power shaving and that are a primary consideration in the prior art.

The aforementioned objects and advantages of the invention are unacknowledged, and unanticipated in the prior art in the context of fast charging methods for an EV in light-duty situations where only low EV volumes are involved, idle periods between EV charging cycles are substantial, and/or relatively low primary power is available. In the specialized realm of light-duty EV charging from a charging site having low EV volume due to low primary power (e.g. residential charging sites and small off-grid power stations), there has been a long-felt and particularly acute need for increased EV charging rates, but the need has remained unmet and no one has successfully implemented a process for increasing EV charging rates under the special conditions of light-duty charging sites, nor has anyone taken full advantage of the large power multiplication factors that are possible at charging sites where there are long idle periods between charging cycles.

### SUMMARY OF THE INVENTION

In its broadest sense, a method is disclosed for multiplying power from a primary electric power source through the use of a battery buffer so that the charging rate of an energy storage load (e.g., an EV) during a charging interval may be increased in new and under-served light-duty application areas where long periods exist for accumulating substantial energy in a power buffer. These new uses for a battery buffer are surprising and have not been recognized or anticipated in the prior art. Light-duty applications frequently include situations where power from a primary power source is relatively low and power multiplication factors are high, but applications may also include situations where a high-power primary source is used and there is benefit in more modest power multiplication for increased EV charging speed. The large magnitude of improvement in EV charging rates that is possible at light-duty charging sites using the present invention is surprising and unacknowledged, with possible increases in charging rates of more than thirty times present charging rates at low volume charging sites.

While the primary focus of the invention is upon new uses for the power multiplication feature of a battery power buffer in light-duty applications in order to enable rapid EV charging, there are a number of secondary benefits of the method stemming from the means for storing energy inherent in the invention. Inherent energy storage can provide a number of useful functions in addition to power multiplication, including backup power, transportable power, programmable power, and renewable energy storage. These secondary energy storage features and benefits can accrue with minimal additional hardware means, since existing elements of the invention that are required for fast-charging are utilized in implementing the added features of the invention.

One of the principal new use areas for the disclosed invention include fast EV charging from relatively low power primary power sources typically accessible from the utility lines in residential dwellings, or from solar photovoltaic panels or small motorized generators at residential dwellings. Another substantial application area involves the implementation of power buffering methods for increasing EV charging rates from a small off-grid power station comprising motor-driven generators, solar photovoltaic panels, wind turbine generators, or a combination of these power sources. The small off-grid power station may be fixed or transportable (mobile). In particular, fast EV charging applications using a transportable off-grid power station include military field operations, crisis response actions, and construction activities. Other new application areas for the power buffering method include power boost retrofits for existing EV chargers at public charging stations. In this case, primary power is supplied by the chargers and power boost is added as a retrofit involving minimal modification to existing chargers to increase EV charging rates at public charging stations using extensive infrastructure that already exists.

By identifying new uses for power buffering methods, the invention satisfies a number of long-standing and unmet needs for increased EV charging speeds with objects and advantages that have not been recognized or acknowledged in the prior art. In particular, objects and advantages have not been identified in use areas where the EV traffic is relatively low (resulting in long idle periods for accumulating substantial energy in a power buffer), and/or primary power available for EV charging is relatively low. In many situations falling under this category, the need for large increases in EV charging speed have been acute and long-standing, making the use of power multiplication inherent in the power buffering method of major importance in these cases. Advantages for new use cases involving retrofits to existing charging stations have also been unrecognized and unappreciated, despite the great benefits in increasing EV charging speeds at existing facilities while taking advantage of extensive EV charging infrastructure with minimal facility modification.

### BRIEF DESCRIPTION OF THE DRAWINGS

FIG. 1 shows an overall block diagram of the elements of a preferred embodiment of the invention for storing, managing, and ultimately multiplying power from a primary electric power source in a power buffer for the principal purpose of rapidly charging an electric vehicle from a light-duty charging site having low primary power, with optional provisions for supplying backup AC power, returning stored energy to the utility grid, charging an auxiliary battery, and storing energy from a solar photovoltaic panel.

### DETAILED DESCRIPTION

This document discloses a method for rapidly charging EVs in situations where only one or a small number of EVs are typically recharged in a 24-hour period, thereby comprising a limited category of specialized light-duty EV charging applications. In general, the method is practiced by multiplying power from a primary electric power source by utilizing a power buffer so that the charging rate for an energy storage load onboard an EV during an EV charging interval may be increased above the charging rate for the EV at a charger in which charging power is limited to the power level of the primary power source. Limiting the present invention to low EV volumes and light duty is equivalent to limiting the invention to situations in which relatively long idle periods exist between charging cycles. In this situation, substantial energy can be accumulated in a power buffer and the fast-charging rate can then be maximized and/or sustained over relatively long periods of time. Light-duty applications frequently suffer from especially long EV charging durations using prior art EV charging methods, and consequently light-duty applications have considerable need for improvement in EV charging speed.

More particularly, power may be multiplied in the present invention by first storing energy from a primary power source in an intermediate energy storage device, or power buffer, and then discharging energy stored in the power buffer into an EV battery at a higher rate governed by energy discharge characteristics of the power buffer rather than power flow from the primary power source. In effect, energy from a primary power source is accumulated in the power buffer over a relatively long period of time and then discharged from the power buffer into the EV battery over a relatively short period of time, so that power, which is the amount of energy flow per unit of time, is multiplied and the EV may be rapidly charged. There is no violation of energy conservation since energy is given by the product of power and time and this product is substantially equal during charging and discharging of the power buffer, except for a relatively small energy loss incurred in charging and discharging the power buffer and a small energy loss in storing energy in the power buffer resulting from small leakage currents in the power buffer.

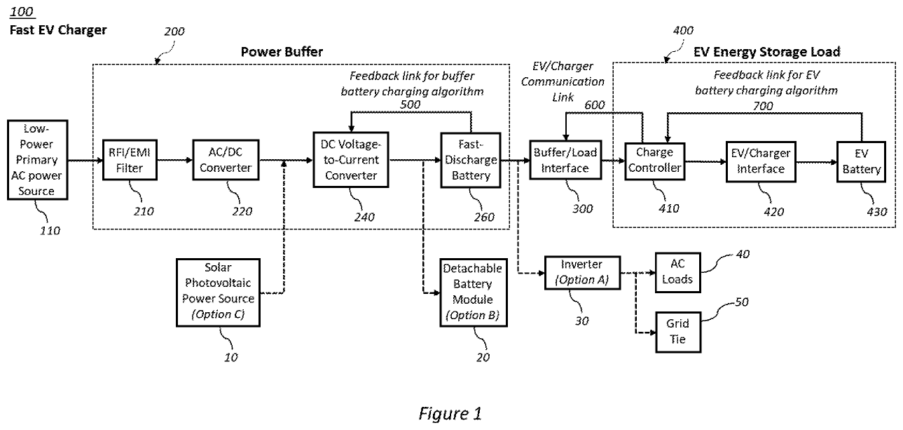

FIG. 1 shows an overall block diagram of physical elements and physical means needed to practice an embodiment of the inventive method for multiplying power from a primary electric power source in a power buffer for charging an EV from a low-power primary power source. FIG.1 applies, for example, to a fast EV charger at a residential dwelling. Similar physical elements could be applied in a number of alternate situations, including situations in which the primary power source comprises a small off-grid power station comprising a motor generator, or a solar photovoltaic panel, or a wind turbine generator, or some combination of these three power sources. Thus, the present detailed discussion will treat the specialized case of a fast EV charger for a residential dwelling with the understanding that the invention may be used in many other light-duty situations, including fast EV charging from a small off-grid power station, and the invention is limited only by the claims listed at the end of this disclosure.

With this caveat, there is great need for increased EV charging rates in a residential dwelling due to the relatively low primary power utilized in a residential dwelling for home-based EV charging stations in the prior art, and, therefore, there is great benefit in multiplying the primary power available in a residential dwelling in order to rapidly charge an electric vehicle (EV) and thereby increase the utility and availability of an EV.

In FIG. 1, principal means for enabling the fast EV charging method of the present invention comprises a fast EV charger 100, with provisions to include the following optional elements that contribute additional functionality beyond fast charging of an EV with minimal additional hardware through the use of shared components: (1) an inverter (Option A) 30 that can provide back-up AC power to AC loads 40 in a residential dwelling (e.g. during a power outage); (2) inverter (Option A) 30 in combination with grid tie 50 for returning excess stored energy in the fast-discharge battery 260 to the utility grid; (3) a detachable battery module (Option B) 20 to provide readily transportable power; and (4) an interface to a solar photovoltaic power source (Option C) 10 or other renewable energy source to add energy to the system in addition to energy supplied by a principal or primary power source.

In the preferred embodiment, the primary electric power source from which energy originates is provided to the fast EV charger 100 from a relatively low power primary AC power source 110, as commonly supplied by a local utility grid near a residential dwelling. A power buffer 200 is provided outside of an electric vehicle comprising the following elements: (1) RFI/EMI filter 210 that connects to the low power primary AC power source 110 and that reduces radio frequency interference (RFI) and electromagnetic interference (EMI) caused by undesirable frequency components that may be generated in converters 220 and 240 in the power buffer 200; (2) an AC/DC converter 220 connected to the RFI/EMI filter 210; (3) a DC voltage-to-current converter 240 connected to the AC/DC converter 220 that provides a predetermined current profile for effective charging of the fast-discharge battery 260 by means of control signals from feedback link 500; and (4) a fast-discharge battery 260 connected to the DC voltage-to-current converter 240. A buffer/load interface 300 is further provided that conveys power from the power buffer 200 to an EV energy storage load 400.

While the primary electric power source shown in the embodiment in FIG. 1 is a low power primary AC power source 110, the primary electric power source may alternatively comprise a primary solar photovoltaic power source, which may also be found at a residential dwelling. In this case, there would be no need for elements in the power buffer 200 for converting AC power to DC power (AC/DC converter 220) since the primary solar photovoltaic power source would provide DC directly. A DC voltage-to-current converter 240 would still be required to properly charge the fast-discharge battery 260 from DC supplied by the primary solar photovoltaic panel. In addition, the supplementary solar photovoltaic power source (Option C) would not be required, since the primary solar photovoltaic power source could provide all of the renewable energy for the fast EV charger 100.

The EV energy storage load 400 is wholly contained onboard an electric vehicle (EV) that is being charged. The EV energy storage load 400 serves as the primary energy source for the EV. As such, the act of charging an EV is synonymous with charging the EV energy storage load 400 within the EV in the present embodiment. The EV energy storage load 400 comprises the following elements: (1) a charge controller 410 connected to the buffer/load interface 300; (2) an EV/charger interface 420 connected to the charge controller 410; and (3) an EV battery 430 connected to the EV/charger interface 420. The charge controller 410 includes an algorithm for adjusting current flow to the energy storage load 400 in a predetermined fashion according to the state-of-charge (SOS) of the EV battery 430 and the condition of the energy storage load 400 as the EV is being charged. The algorithm is designed to minimize charging time, while maintaining safe charging conditions and adequate battery lifetime. For AC coupling to the EV, the charge controller 410 includes elements for rectifying the AC voltages transmitted to the vehicle, and a voltage to current converter for fashioning the charge controller into a current source that generates the predetermined current waveforms needed to charge the EV battery 430. For DC coupling to the EV, the AC rectifier would be eliminated in the charge controller 410. The EV/charger interface 420 provides any buffers or transitions between the charge controller 410 and the EV battery 430, including any general-purpose power busses that may be applied in the EV.

The buffer/load interface 300 provides power transfer between the power buffer 200 outside the EV and the EV energy storage load 400 inside the EV. In a preferred embodiment, the buffer/load interface 300 may incorporate an electrical wire/cable with a detachable interconnect (plug) that connects directly to the EV. The interconnect design for the invention may copy any of several standard plug designs so that backward compatibility is maintained with a large number of electric vehicles that currently utilize a plug-in connection for EV charging. Power in the form of DC or power-line-like AC (most commonly 50-400 Hz) may be transmitted to the EV using this type of cable interconnect. When DC power is transmitted across the buffer/load interface 300, the buffer/load interface 300 may be directly connected to the charge controller 410 via a plug-in wire connection, or the buffer/load interface 300 may include power conversion circuitry to transform DC voltages from the fast discharge battery 260 in the power buffer 200 into higher or lower voltages compatible with the charge controller 410 in the energy storage buffer 400. Analogously, when power-line-like AC is transmitted across the buffer/load interface 300, the buffer/load interface 300 will include power conversion circuitry to transform DC voltages from the fast-discharge battery 260 into power-line-like AC compatible with the charge controller 410.

In an alternative embodiment, the buffer/load interface may incorporate a plug-less (wireless) inductive coupling system that transmits AC power to the EV energy storage load 400 at a substantially higher frequency than power-line frequencies. In this case, AC frequencies would extend typically from the kilohertz range to the megahertz range. The buffer/load interface 300 would then include power conversion circuitry for transforming DC power from the fast discharge battery 260 into the high frequency AC power that would be transmitted wirelessly (i.e., without a plug-in connection) to the charge controller 410. In this case, the charge controller 410 would include power conversion circuitry to transform the high frequency AC from the buffer/load interface 300 offboard the EV into DC that is suitable for charging the EV battery 430 via the EV/charger interface 420.

In each specific implementation, information on the SOC (state-of-charge) of the EV battery 430, energy usage of the EV, and other data related to general performance and status is transmitted from the energy storage load 400 to the buffer/load interface 300 via EV/charger communication link 600. From there, the EV/charger communication link 600 provides to a master control system information related to EV system parameters and overall charging system status onboard the EV.

The low power primary AC power source 110 typically supplies energy at a nominal 120 Volts 60 Hz single-phase AC or a nominal 240 Volts 60 Hz two-phase AC in a residential dwelling in the United States. Other voltages and AC frequencies that are customary in other countries around the world may also be used with the invention. Common current levels for a dwelling in the United States range from 100-200 Amps rms (root mean squared). While it is therefore possible, in principle, to supply as much as 24 kW from 100 Amp, 240 Volt electric service, or 48 kW from 240 Volt 200 Amp service, much less power is used in practice for charging an electric automobile at a residential dwelling, partially because much of the power in a dwelling must be reserved for other loads in and around the home. In fact, present standard practice utilizes standardized Level 1 or Level 2 chargers for charging an electric automobile in a residential dwelling. These standard chargers typically operate well below maximum input service ratings for a residential dwelling.

For example, Level 1 chargers have a maximum power rating of 1.9 kW, while Level 2 chargers have a maximum power rating of 19.2 kW. Level 1 chargers may be plugged into an ordinary 120 Volt, 20 Amp outlet in a home, but about 21 hours will be required to recharge a depleted 50 kW-hr battery in an EV to 80% capacity. A Level 2 charger utilizes the 240 Volt service in a dwelling at 18-80 Amps of current. A Level 2 charger operating at maximum output could bring a depleted 50 kW-hr EV battery to 80% capacity in 2.6 hours. While a Level 2 charger has a maximum power rating of 19.2 kW, power levels of less than 7 kW are more typically applied in a residential dwelling. At 7 kW, a depleted 50 kW-hr EV battery would be recharged to 80% capacity (40 kW-hrs.) in about 5.7 hours. These long recharging times using current practice in a residential dwelling are inconvenient and undesirable. In an emergency situation, for example a situation requiring critical medical care, long recharging times may even put lives at risk when immediate transport to a medical center is needed.

Long charging times of conventional EV charging methods in a residential dwelling will be mitigated by the present invention since energy stored in the fast-discharge battery 260 of the power buffer 200 may be applied to the EV battery 430 in the EV energy storage load 400 at a substantially increased charging rate, governed by the energy discharge characteristics of the fast-discharge battery 260 rather than the more limited peak power rating of the low power primary AC power source 110.

For example, using one of the many types of fast-discharge batteries that are commercially available in place of the fast-discharge battery 260 in the embodiment in FIG.1, such as the Sib lithium-ion rechargeable battery manufactured by Toshiba, energy stored in the power buffer 200 may be discharged into the EV energy storage load 400 in as little as six minutes. Discharging 40 kW-hrs. of energy stored in the power buffer 200 into the EV energy storage load 400 in six minutes is equivalent to charging the EV energy storage load 400 at a power level of 400 kW, which is twenty-one times faster than EV charging from a Level 2 charger at maximum power (19.2 kW). Even if all of the available AC power in a residential dwelling could be used for direct EV charging by conventional means, which leaves no power for other household loads and heavily taxes utility services, the 400 kW equivalent power of the present method would still charge an EV over eight times faster than the maximum conventional charging rate at the highest voltage (240V) and current (200 Amps) typically available in a residential dwelling.

In principle, the invention can be applied using any rechargeable battery that has a discharge power capacity greater than the primary electric power level. The various types of lithium-ion batteries with liquid electrolytes fall into this category. Of particular interest, lithium titanate oxide (LTO) batteries can be discharged at rates in excess of 10 C (discharge current ten times the current used in the one-hour battery capacity rating), making it possible to charge compatible EV batteries in as little as six minutes. The Toshiba battery mentioned above falls into this category of rechargeable LTO lithium-ion battery chemistries.

Other battery types that may provide very high discharge rates beneficial to the invention include solid-state batteries, vertically-aligned carbon nanotube batteries, lithium-sulfur batteries, graphene batteries, aluminum-air batteries, dual-carbon batteries, sodium-ion, aluminum-ion, and carbon-ion batteries, and super-capacitor-like batteries. Of these alternative battery types, solid-state batteries show great promise for power multiplication in the present invention. Solid-state batteries are commonly considered a type of lithium-ion battery that replaces the liquid electrolyte with a solid electrolyte, resulting in improvements in energy density and charge/discharge rate.

As an important feature of the present invention, energy is applied to the power buffer 200 in a residential dwelling on a schedule that is largely independent of the EV schedule. In particular, the EV and its associated EV battery 430 do not need to be present while energy is accumulated in the power buffer 200. Energy can then be accumulated in the power buffer 200 on a very flexible schedule at any selected interval throughout the day or night as determined by the EV owner. Since the power buffer 200 enables fast EV charging that only requires vehicle presence over a substantially reduced time interval, the EV battery 430 may be charged on a very flexible schedule at almost any time during the day or night.

System elements of the fast EV charger 100 needed for charging the EV battery 430 can serve multiple functions in a residential dwelling that would not be found at a single-purpose public charging station. For example, to service the wide variety of electrical loads in a residential dwelling, energy stored in the power buffer 200 could be used to provide backup power for a residential dwelling by converting DC power from the fast charge battery 260 into 60 Hz AC power in the optional inverter 30 connected to the fast charge battery 260. Backup power could then be used to supply energy to a residential dwelling during power outages in addition to supplying energy to an EV. For example, 50 kW-hrs. of energy storage in the fast-charge battery 260 of the power buffer 200 could supply a relatively high demand level of 5 kW to a residential dwelling for ten hours during a power outage on the utility grid, effectively eliminating the need for a separate motorized backup generator. Excess energy may also be returned to the utility grid by means of inverter 30 and grid tie 50. Power transmission back to the utility grid will enable the sale of excess energy to the utility company in a process known commonly as “net metering.”

In a further optional function of the fast EV charger 100, energy from a renewable energy source, such as a solar photovoltaic power source 10, may be added to the energy supplied to the fast-discharge battery 260 by the low-power primary AC power source 110. In this case, the solar photovoltaic power source 10 would tap into the DC voltage-to-current converter 240 to control charging of the fast-discharge battery from the solar photovoltaic power source 10. Existing elements of the fast EV charger 100 required for fast EV charging may then be utilized to convey energy from the solar photovoltaic power source 10 to the EV battery 430 and/or AC loads 40 via inverter 30. Alternatively, energy from the solar photovoltaic power source may be conveyed to the utility grid via inverter 30 in combination with grid tie 50. Thus, equipment inherent in the fast-charger 100 provides all of the auxiliary power conversion and transmission equipment needed for a complete solar photovoltaic power station and energy delivery system using pre-existing hardware already in place for fast EV charging. The only additional elements needed to implement a complete solar photovoltaic power generation and delivery system are the solar photovoltaic cells.

It should be understood that while the preferred embodiment comprises a method for rapidly charging an EV using limited AC power at a residential dwelling, the method can be applied to any light-duty EV charging situation in which the primary AC power is relatively low and there is great need for increasing EV charging rates. In particular, functional block diagrams similar to FIG. 1 would apply in many under-served situations where a relatively low power AC power source may be all that is available. For example, as pointed out previously in this disclosure, relatively low primary power can be found at shared public charging stations in the form of standard Level 1 and Level 2 chargers. In this case, the method could be applied to existing public charging stations by providing a retrofit power boost system at these sites.

It has also been pointed out in this disclosure that the method can be applied to great advantage at any EV charging site supplied by a relatively small off-grid power station (e.g., less than about 50 kilowatts) in which primary electric power is supplied by a motor-driven generator, or a solar photovoltaic panel, or a wind turbine generator, or a combination of these three power sources. Specific EV charging sites that would typically utilize a small off-grid power station under this broad category include military bases, disaster relief sites, construction areas, and special outdoor events.

It should be understood that the method is not limited to multiplying power from an AC power source in order to increase EV charging rates. Rather, the method can utilize a DC primary power source in place of the primary AC power source, as would be the case when the primary power source comprises a photovoltaic panel, as already mentioned, or a primary DC (direct current) EV charger, wind turbine DC generator, or other DC power supply.

It should also be understood that the method applies not only to EV charging sites that have relatively low primary power and associated light-duty EV use, but also to sites that have high primary power yet low EV use. The common element in all cases is the limitation of light-duty EV charging where only a small number of EVs may be charged in a 24-hour period and substantial energy may be accumulated in a power buffer between charging cycles so that large power and long power duration can be established during the EV charging cycle. Charging rates at many light-duty EV charging sites are typically very low using prior art methods. As a result, there has been an acute and long-standing need to increase EV charging rates for improved utility of EVs at typical light-duty charging sites, including residential dwellings and small off-grid power stations.

It should also be clear that the invention can be practiced not only to increase the charging rate of electric automobiles in light-duty situations, but the invention can be practiced advantageously to increase the charging rates of other electric vehicles, including light-duty electric trucks, electric bicycles, electric motor scooters, electric motorcycles, electric carts (e.g., electric golf carts, recreational carts, and utility carts), and electric fork-lift trucks. The term “electric vehicle” used in the following claims is to be interpreted in this broader sense. With these caveats, implementations of the invention are covered by the following claims

The invention claimed is:

1. A method for rapidly charging an electric vehicle from a residential dwelling, the method comprising:
providing a primary electric power source at said residential dwelling;
providing a power buffer;
providing a fast-discharge battery within said power buffer;
providing a buffer/load interface;
providing an energy storage load within said electric vehicle;
providing an electric vehicle battery within said energy storage load;
providing means for transmitting power from said primary electric power source at said residential dwelling to said fast-discharge battery within said power buffer;
providing means for transmitting power from said fast-discharge battery within said power buffer to said buffer/load interface;
providing means for transmitting power from said buffer/load interface to said electric vehicle battery within said energy storage load;
transmitting power from said primary electric power source at said residential dwelling to said fast-discharge battery within said power buffer,
whereby a power buffer energy may be accumulated in said fast-discharge battery, whereby said power buffer energy may be accumulated and stored in said fast-discharge battery whether or not said electric vehicle is present at said residential dwelling;
transmitting power from said fast-discharge battery to said buffer/load interface;
transmitting power from said buffer/load interface to said electric vehicle battery within said energy storage load within said electric vehicle,
wherein a power buffer energy discharge rate of said power buffer into said buffer/load interface is higher than an energy supply rate of said primary electric power source at said residential dwelling, whereby power from said primary electric power source at said residential dwelling may be multiplied and a charging rate of said electric vehicle may be increased so that said electric vehicle may be rapidly charged from said residential dwelling.

2. The method of claim 1, wherein said primary electric power source comprises a solar photovoltaic power source.

3. The method of claim 1, wherein said fast-discharge battery comprises a lithium-ion battery, wherein said lithium-ion battery may be effective in multiplying power from said primary electric power source, whereby a charging rate of said electric vehicle may be increased.

4. The method of claim 1, wherein said fast discharge battery comprises a solid-state battery, wherein said solid-state battery may be effective in multiplying power from said primary electric power source, whereby a charging rate of said electric vehicle may be increased.

5. The method of claim 1 wherein said fast-discharge battery comprises a used or repurposed rechargeable electric vehicle battery wherein said repurposed rechargeable battery may be effective in multiplying power from said primary electric power source, whereby a charging rate of said electric vehicle may be increased even though said used or repurposed rechargeable battery may not be effective in directly powering an electric vehicle, whereby cost for practicing the method may be reduced and disposal issues for used electric vehicle batteries may be mitigated.

6. The method of claim 1, wherein said means for transmitting power from said buffer/load interface to said electric vehicle battery comprises an inductive coupling means.

7. The method of claim 1, wherein said means for transmitting power from said power buffer to said electric vehicle battery comprises a plug-in cable interconnect, whereby said method may be backward compatible with a large number of common electric vehicles that utilize a plug-in cable connection for charging.

8. The method of claim 1, further including means for converting DC (direct current) from said fast-discharge battery into AC (alternating current), whereby said fast-discharge battery may be used in said residential dwelling for backup AC (alternating current) power, or auxiliary AC (alternating current) power, or supplemental utility grid power, or AC (alternating current) electric vehicle charging power.

9. The method of claim 1, further including means for transporting said fast-discharge battery, whereby said fast-discharge battery may be used for powering an electrical device away from said residential dwelling, whereby said fast-discharge battery may be used to recharge a stranded electric vehicle or provide supplemental power for extending the driving range of an electric vehicle or supply mobile power for charging an electric vehicle where grid power is unavailable or inaccessible.

10. The method of claim 9 wherein said means for transporting said fast-discharge battery comprises a towable trailer on which is mounted said fast-discharge battery.

11. The method of claim 9, further including means for converting DC (direct current) from said fast-discharge battery into AC (alternating current), whereby power may be supplied to electrical devices requiring AC (alternating current), whereby common AC powered equipment, appliances, or power tools may be energized when grid power is unavailable or inaccessible.

12. The method of claim 1, further including means for removing and transporting a portion of said fast-discharge battery, wherein said portion is of a weight that may be transported by a human, whereby said portion of said fast-discharge battery may serve as a convenient and readily deployable light-duty power source.

13. A method for rapidly charging an electric vehicle from a small off-grid power station, the method comprising:
providing a primary electric power source comprising a small off-grid power station;
providing a power buffer;
providing a fast-discharge battery within said power buffer;
providing a buffer/load interface;
providing an energy storage load within said electric vehicle;
providing an electric vehicle battery within said energy storage load;
providing means for transmitting power from said small off-grid power station to said power buffer;
providing means for transmitting power from said power buffer to said buffer/load interface;
providing means for transmitting power from said buffer/load interface to said electric vehicle battery within said energy storage load;
energizing said small off-grid power station;
transmitting power from said small off-grid power station to said fast-discharge battery within said power buffer,
whereby a power buffer energy may be accumulated in said fast-discharge battery, whereby said power buffer energy may be accumulated and stored in said fast-discharge battery whether or not said electric vehicle is present while power is transmitted to said fast-discharge battery from said small off-grid power station;
transmitting power from said fast-discharge battery to said buffer/load interface;
transmitting power from said buffer/load interface to said electric vehicle battery within said energy storage load within said electric vehicle,
wherein a power buffer energy discharge rate of said power buffer is higher than an energy supply rate of said small off-grid power station, whereby power from said small off-grid power station may be multiplied and said electric vehicle may be rapidly charged.

14. The method of claim 13, wherein said electric vehicle is utilized for transport in a military operation, whereby said method for rapidly charging an electric vehicle may improve electric vehicle responsiveness and availability for fast-paced maneuvers and troop transport at a military post.

15. The method of claim 13, wherein said electric vehicle is utilized for transport in an emergency response activity, whereby said method for rapidly charging an electric vehicle may improve electric vehicle responsiveness and availability in a crisis or an emergency.

16. The method of claim 13, wherein said electric vehicle is utilized for transport in a construction activity, whereby said method for rapidly charging an electric vehicle may improve electric vehicle responsiveness and availability for time-sensitive activities at a construction site.

17. The method of claim 13, wherein said electric vehicle is utilized for transport in an outdoor activity, whereby said method for rapidly charging an electric vehicle may improve electric vehicle responsiveness and availability for time-sensitive or fast-paced activities at an outdoor event.

18. A method for rapidly charging an energy storage load onboard an electric vehicle from a light-duty charging site, wherein a power factor during the charging cycle for said energy storage load is less than 0.7, the method comprising:
providing a primary electric power source;
providing a power buffer connected to said primary electric power source;
providing a fast-discharge battery within said power buffer;
providing a buffer/load interface connected to said power buffer;
providing an energy storage load onboard said electric vehicle;
providing means for transmitting power from said power buffer to said buffer/load interface;
providing means for transmitting power from said buffer/load interface to said energy storage load onboard said electric vehicle;
energizing said primary electric power source;
transmitting power from said primary electric power source to said fast-discharge battery within said power buffer,
whereby a power buffer energy may be accumulated in said fast-discharge battery, whereby said power buffer energy may be accumulated and stored in said fast-discharge battery whether or not said electric vehicle is present while power is transmitted to said fast-discharge battery from said primary electric power source;
charging said energy storage load using said power buffer energy,
wherein a power buffer energy discharge rate of said power buffer may be higher than an energy supply rate of said primary electric power source, whereby power from said primary electric power source may be multiplied and said energy storage load onboard said electric vehicle may be rapidly charged.

19. The method of claim 18, wherein said primary electric power source comprises a solar photovoltaic power source, whereby said energy storage load may be rapidly charged using renewable energy with no need for drawing power from a utility grid, whereby power demands on the utility grid may be reduced, especially as large numbers of electric vehicles are manufactured and deployed.

20. The method of claim 18, wherein said primary electric power source comprises a charger for an electric vehicle, whereby said energy storage load may be rapidly charged using existing infrastructure for charging electric vehicles, whereby substantial economies may be realized in rapidly charging said electric vehicle from a large number of existing charging sites and minimal modifications to said existing infrastructure may be needed.
